(19) United States
(12) Patent Application Publication
(10) Pub. No.: US 2013/0176457 A1
(43) Pub. Date: Jul. 11, 2013

(54) AUTO PROCESSING IMAGES HAVING ARBITRARY REGIONS OF INTEREST

(71) Applicant: Sawada Yasuhiro, Tokyo (JP)

(72) Inventor: Sawada Yasuhiro, Tokyo (JP)

(21) Appl. No.: 13/538,330

(22) Filed: Jun. 29, 2012

Related U.S. Application Data
(60) Provisional application No. 61/584,775, filed on Jan. 9, 2012.
(60) Provisional application No. 61/584,776, filed on Jan. 9, 2012.

(51) Int. Cl. G06K 9/46; G06F 3/041; H04N 5/76

(52) U.S. Cl. 348/231.99; 382/195; 345/173; 348/E05.031

(57) ABSTRACT

Systems and methods may provide for using fixed functionality logic to determine one or more statistics for multi-pixel cells of an image frame divided into a grid of multi-pixel cells. Additionally, a programmable processor can be used to conduct an auto process evaluation of at least one of the one or more statistics for multi-pixel cells identified as part of one or more regions of interest in the image frame.

### CROSS REFERENCE TO RELATED APPLICATIONS

The present application claims the benefit of priority to U.S. Provisional Patent Application No. 61/584,775, filed on Jan. 9, 2012.

### BACKGROUND

1. Technical Field

Embodiments generally relate to image processing. More particularly, embodiments relate to auto processing images that have arbitrary regions of interest.

2. Discussion

Conventional cameras may have auto processing functionality that attempts to improve image quality by conducting auto exposure (“AE”), auto white balance (“AWB”), and auto focus (“AF”) activities (collectively, “3A processes”) with regard to a particular region of interest (ROI) in the image. Traditionally, the region of interest may have been on center of the frame.

More recently, face detection and touch screen features may be used in cameras (e.g., smart phone or tablet cameras), wherein the 3A processes might be made to target a detected face or touched area in the image, wherever that target might be located or whatever the size of the target (e.g., face). Unfortunately, such an increased flexibility may result in arbitrarily located and variably sized regions of interest. Large, or dense, ROIs can significantly increase the processing overhead of programmable 3A implementations, while the variable and arbitrary nature of the ROIs can make efficient fixed functionality logic 3A implementations challenging. Indeed, reduced predictability with regard to the location and size of the regions of interest in a given image may lead to increased power consumption as well as reduced battery life.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is an illustration of an example of an image divided into a grid of multi-pixel cells according to an embodiment;

FIG. 2 is a block diagram of an example of a method of processing frame data according to an embodiment;

FIG. 3 is an illustration of an example of a statistical weighting scheme as applied to an image according to an embodiment; and

FIG. 4 is a block diagram of an example of a system according to an embodiment.

### DETAILED DESCRIPTION

Embodiments may include a method in which fixed functionality logic is used to determine one or more statistics for multi-pixel cells of an image frame divided into a grid of multi-pixel cells. Additionally, a programmable processor may be used to evaluate at least one of the one or more statistics for multi-pixel cells identified as part of one or more regions of interest in the image frame.

Embodiments may also include a chip having fixed functionality logic to determine one or more statistics for multi-pixel cells of an image frame divided into a grid of multi-pixel cells, and a programmable processor. The system may also include memory having a set of instructions which, if executed by the programmable processor, cause the programmable processor to evaluate at least one of the one or more statistics for multi-pixel cells identified as part of one or more regions of interest in the image frame.

Moreover, embodiments may include a system having a camera to capture an image frame, and a chip having fixed functionality logic to determine one or more statistics for multi-pixel cells of the image frame, wherein the image frame is to be divided into a grid of multi-pixel cells. The system can also have memory with a set of instructions which, if executed by the programmable processor, cause the programmable processor to evaluate at least one of the one or more statistics for multi-pixel cells identified as part as one or more regions of interest in the image frame.

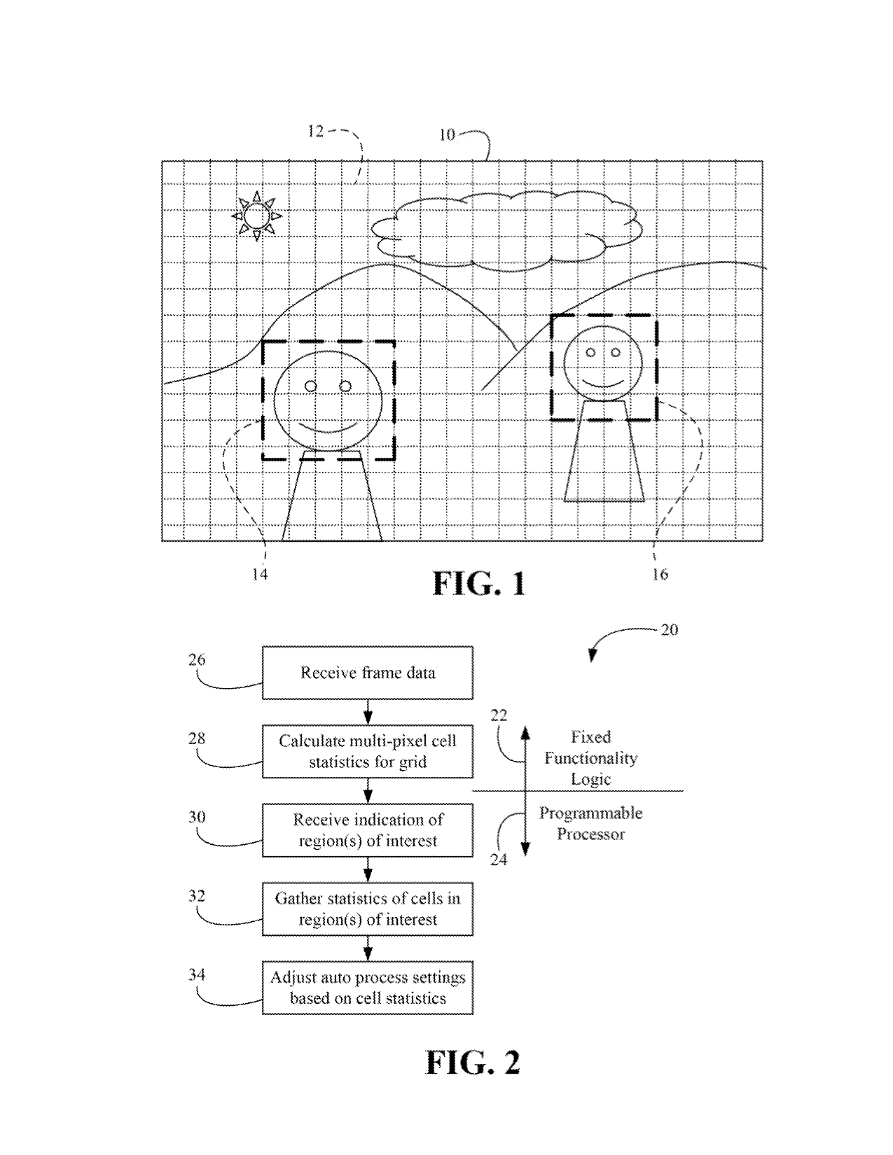

Turning now to FIG. 1, an image frame 10 is shown, wherein regions of interest 14, 16 may be determined for the image frame 10 based on, for example, data received from a touch screen (e.g., user selection from a set of region of interest/ROI candidates) and/or face detection logic. For example, a first ROI 14 may correspond to a face of an individual who is relatively close to the camera, whereas a second ROI 16 might correspond to an individual who is farther away from the camera. Accordingly, the illustrated ROIs 14, 16 have different sizes and those sizes can vary from frame to frame depending upon the composure of the particular scene being captured. Moreover, as the location of the individuals in the scene may change, the position of the ROIs 14, 16 can also be quite arbitrary.

In the illustrated example, the image frame 10 is divided into a grid 12 of multi-pixel cells. The illustrated cells may be considered “multi-pixel” cells in the sense that each cell can include multiple pixels of the image frame 10. For example, for a frame having 2M (1920×1080) pixels, the cell size might be 128×128 pixels. In such a case, the number of multi-pixel cells would be approximately 15×8. In the illustrated example, the grid 12 is a 23×15 array of multi-pixel cells. Additionally, the grid 12 can be deployed over the image frame 10 in a fixed arrangement, wherein the cell size, grid size, and cell/grid shape (e.g., squares, rectangles, etc.), may all be a matter of design preference.

As will be discussed in greater detail, fixed functionality logic (e.g., digital signal processor/DSP) may be used to determine auto process related statistics for each of the multi-pixel cells of the grid 12, wherein a programmable processor (e.g., programmable micro control unit/MCU, central processing unit/CPU) may be used to conduct an auto process evaluation of the statistics for the multi-pixel cells that are part of the ROIs 14, 16. Thus, the fixed functionality logic, which may be well suited for straightforward processes with massive amounts of image data, can be used to handle the statistics for the entire grid 12. The programmable processor, on the other hand, may be generally better suited for more intelligent processing and is used to conduct 3A processes.

FIG. 2 shows a method 20 of processing frame data. The method 20 may be implemented as a set of logic instructions stored in a machine- or computer-readable storage medium such as random access memory (RAM), read only memory (ROM), programmable ROM (PROM), flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, digital signal processor (DSP), application specific integrated circuit (ASIC), complementary metal oxide semiconductor (CMOS) or transistor-transistor logic (TTL) technology, or any combination thereof. In the illustrated example, a first portion 22 of the method 20 is implemented in fixed functionality logic, whereas a second portion 24 of the method 20 is implemented in a programmable processor. For example, the first portion 22 of the method 22 could be implemented using any of the aforementioned circuit technologies. Moreover, computer program code to carry out operations shown in the second portion 24 may be written in any combination of one or more programming languages, including an object oriented programming language such as C++ or the like and conventional procedural programming languages, such as the “C” programming language or similar programming languages.

Illustrated processing block 26 provides for receiving frame data. The frame data, which may be associated with a still image or video content, could be received from an image capture device, network interface, memory device, and so forth. In one example, the frame data includes an image frame that is divided into a grid of multi-pixel cells. Statistics may be calculated/determined for the multi-pixel cells at block 28, wherein the statistics may include, for example, mean brightness (for AE), contrast (for AF), color (for AWB), etc., on a cell-by-cell basis. As already noted, using fixed functionality logic to determine the statistics can enable the strengths of fixed functionality computing to be leveraged over large amounts of image data.

An indication of one or more regions of interest may be received by the programmable processor at block 30, wherein the regions of interest can be identified via a touch screen interface, face detection logic, and so forth. Illustrated block 32 provides for using the programmable processor to gather the statistics for cells corresponding to the regions of interest, wherein one or more auto process settings may be adjusted at block 34. In this regard, an auto process evaluation may be conducted in order to determine one or more relevant 3A parameters for the ROIs. For example, an AF program could maximize the contrast (for one or more of the ROIs), an AE program may adjust brightness, and an AWB program may adjust skin color to make it appear more natural.

Of particular note is that the use of multi-pixel cell statistics can significantly reduce the amount of data to be processed by the programmable processor. For example, in the case of a 15×8 grid of multi-pixel cells, the programmable processor would only need to handle on the order of hundreds of units of data rather than millions of data units (e.g., if auto process evaluation were conducted for the entire frame). As a result, power consumption and cost can be reduced, and battery life may be extended.

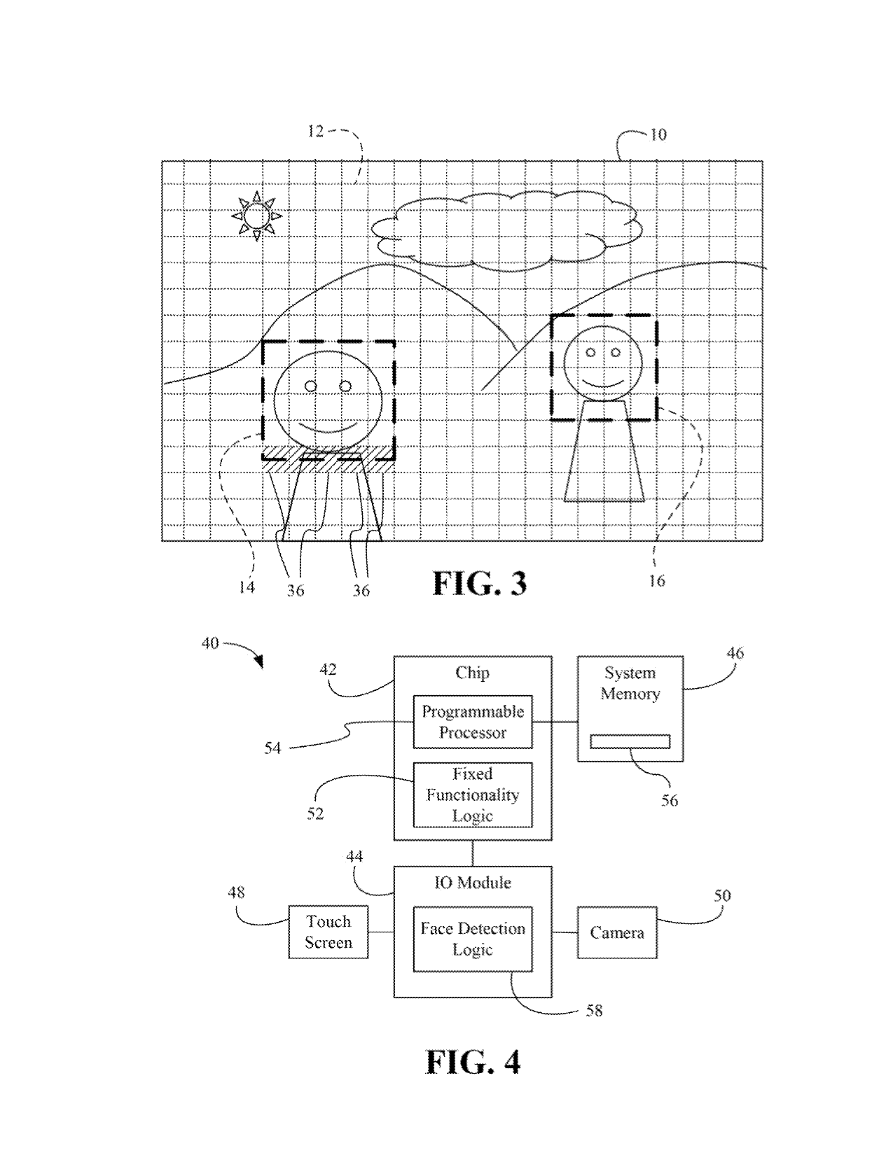

FIG. 3 generally demonstrates that the statistics may be weighted based on a cell percentage covered by the regions of interest. More particularly, the statistics of multi-pixel cells 36 overlapping with the first region of interest 14 might be weighted less than the remaining multi-pixel cells of the first region of interest 14 because a portion of the cells 36 falls outside the region of interest 14. Thus, the statistics for the cells 36 may be weighted 50%, whereas the statistics for the remaining cells within the first region of interest 14 could be weighted at 100%. Similarly, the statistics for the cells included in the second region of interest 16 would be weighted at 100%, in the example shown.

FIG. 4 shows a system 40 that may be part of a mobile platform such as a digital camera, laptop, personal digital assistant (PDA), wireless smart phone, media player, imaging device, mobile Internet device (MID), any smart device such as a smart phone, smart tablet and so forth, or any combination thereof. The system 40 may also be part of a fixed platform such as a personal computer (PC), smart TV, server, workstation, etc. The illustrated system 40 includes a chip 42, an input/output (IO) module 44, system memory 46, a touch screen 48, and a camera 50. The camera 50 may capture an image frame, wherein the chip 42 can have fixed functionality logic 52 to determine one or more statistics for multi-pixel cells of the image frame. The image frame can be divided into a grid of multi-pixel cells, as already discussed. The illustrated system 40 also includes a programmable processor 54 and a set of instructions 56 stored in the system memory 46, wherein the system memory 46 could include, for example, double data rate (DDR) synchronous dynamic random access memory (SDRAM, e.g., DDR3 SDRAM JEDEC Standard JESD79-3C, April 2008) modules. The modules of the system memory 46 may be incorporated into a single inline memory module (SIMM), dual inline memory module (DIMM), small outline DIMM (SODIMM), and so forth.

If executed by the programmable processor 54, the instructions 56 may cause the programmable processor 54 to conduct an auto process evaluation of a subset of the statistics determined by the fixed functionality logic 52. The statistics might include, for example, cell-by-cell mean brightness, cell-by-cell mean contrast, cell-by-cell mean color, and so forth, as already discussed. In one example, the auto process evaluation is conducted for multi-pixel cell statistics that are identified as part of one or more regions of interest in the image frame, wherein the touch screen 48 and/or a face detection logic module 58 may be used to arbitrarily identify the regions of interest. Moreover, the fixed functionality logic 52 may be part of an image signal processor (not shown) that incorporates the programmable processor 54.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware, elements and/or software elements may vary in accordance with any number of factors, such, as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments of the present invention are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A system comprising:
a camera to capture an image frame;
a chip including,
fixed functionality logic to determine one or more statistics for multi-pixel cells of the image frame, wherein the image frame is to be divided into a grid of multi-pixel cells,
a programmable processor; and
memory including a set of instructions which, if executed by the programmable processor, cause the programmable processor to evaluate at least one of the one or more statistics for multi-pixel cells identified as part as one or more regions of interest in the image frame.

2. The system of claim 1, further including:
a touch screen interface; and
a face detection logic module, wherein the instructions, if executed, cause the programmable processor to receive an identification of the one or more regions of interest from one or more of the touch screen interface and the face detection logic module.

3. The system of claim 1, wherein the fixed functionality logic is part of an image signal processor that incorporates the programmable processor.

4. The system of claim 1, wherein the instructions, if executed, cause the programmable processor to adjust an auto exposure setting associated with the image frame.

5. The system of claim 1, wherein the instructions, if executed, cause the programmable processor to adjust an auto focus setting associated with the image frame.

6. The system of claim 1, wherein the instructions, if executed, cause the programmable processor to adjust an auto white balance setting associated with the image frame.

7. The system of claim 1, wherein the instructions, if executed, cause the programmable processor to weight at least one of the one or more statistics based on a cell percentage covered by at least one of the one or more regions of interest.

8. The system of claim 1, wherein the one or more statistics are to include a cell-by-cell mean brightness statistic.

9. The system of claim 1, wherein the one or more statistics are to include a cell-by-cell mean contrast statistic.

10. The system of claim 1, wherein the one or more statistics are to include a cell-by-cell mean color statistic.

11. A chip comprising:
fixed functionality logic to determine one or more statistics for multi-pixel cells of an image frame divided into a grid of multi-pixel cells;
a programmable processor to evaluate at least one of the one or more statistics for multi-pixel cells identified as part of one or more regions of interest in the image frame.

12. The chip of claim 11, wherein the programmable processor is to receive an identification of the one or more regions of interest from one or more of a touch screen interface and a face detection logic module.

13. The chip of claim 11, wherein the fixed functionality logic is part of an image signal processor that incorporates the programmable processor.

14. The chip of claim 11, wherein the programmable processor is to adjust an auto exposure setting associated with the image frame.

15. The chip of claim 11, wherein the programmable processor is to adjust an auto focus setting associated with the image frame.

16. The chip of claim 11, wherein the programmable processor is to adjust an auto white balance setting associated with the image frame.

17. The chip of claim 11, wherein the programmable processor is to weight at least one of the one or more statistics based on a cell percentage covered by at least one of the one or more regions of interest.

18. The chip of claim 11, wherein the one or more statistics are to include a cell-by-cell mean brightness statistic.

19. The chip of claim 11, wherein the one or more statistics are to include a cell-by-cell mean contrast statistic.

20. The chip of claim 11, wherein the one or more statistics are to include a cell-by-cell mean color statistic.

21. A method comprising:
using fixed functionality logic to determine one or more statistics for multi-pixel cells of an image frame divided into a grid of multi-pixel cells; and
using a programmable processor to evaluate at least one of the one or more statistics for multi-pixel cells identified as part of one or more regions of interest in the image frame.

22. The method of claim 21, further including receiving an identification of the one or more regions of interest from one or more of a touch screen interface and a face detection logic module.

23. The method of claim 21, further including using the programmable processor to adjust an auto exposure setting associated with the image frame.

24. The method of claim 21, further including using the programmable processor to adjust an auto focus setting associated with the image frame.

25. The method of claim 21, further including using the programmable processor to adjust an auto white balance setting associated with the image frame.

26. The method of claim 21, further including using the programmable processor to weight at least one of the one or more statistics based on a cell percentage covered by at least one of the one or more regions of interest.

27. The method of claim 21, wherein the one or more statistics include a cell-by-cell mean brightness statistic.

28. The method of claim 21, wherein the one or more statistics include a cell-by-cell mean contrast statistic.

29. The method of claim 21, wherein the one or more statistics include a cell-by-cell mean color statistic.
